(19) United States
(12) Patent Application Publication
(10) Pub. No.: US 2023/0386732 A1
(43) Pub. Date: Nov. 30, 2023

(54) PATCH TYPE TRANSFORMER

(71) Applicant: Mianyang Pulse Electronics Co., LTD., Mianyang City (CN)

(72) Inventors: Jia TANG, Mianyang City (CN); Thuyen DINH, San Diego, CA (US); Mohammad SABOORI, San Diego, CA (US); Hamlet ABEDMAMOORE, San Diego, CA (US)

(21) Appl. No.: 17/893,452

(22) Filed: Aug. 23, 2022

(30) Foreign Application Priority Data
May 25, 2022 (CN) 202210579513.7

(51) Int. Cl. H01F 27/29; H01F 27/30; H01F 27/26; H01F 27/32

(52) U.S. Cl. CPC H01F 27/292; H01F 27/30; H01F 27/26; H01F 27/32

(57) ABSTRACT

A patch type transformer includes a magnetic core and four coils wound around a winding portion of the magnetic core. A first flange portion and a second flange portion of the magnetic core are respectively connected to two ends of the winding portion. First to fourth pads are sequentially arranged on the first flange portion along a first direction. Fifth to eighth pads are sequentially arranged on the second flange portion along a second direction opposite to the first direction. Two ends of the first coil are respectively connected to the first pad and the seventh pad. Two ends of the second coil are respectively connected to the third pad and the fifth pad. Two ends of the third coil are respectively connected to the second pad and the eighth pad. Two ends of the fourth coil are respectively connected to the fourth pad and the sixth pad.

### RELATED APPLICATIONS

This application claims priority to Chinese Application Serial Number 202210579513.7, filed May 25, 2022, the disclosures of which are incorporated herein by reference in their entireties.

### BACKGROUND

### Field of Invention

The present invention relates to a transformer. More particularly, the present invention relates to a patch type transformer.

### Description of Related Art

Communication networks usually require the use of a transformer to meet safety requirements of the electronic product. The transformer is mainly composed of a magnetic core, a primary coil, and a secondary coil. The primary coil and the secondary coil are wound on the magnetic core. In general, the primary coil and the secondary coil need to maintain a certain electrical distance, so that the transformer can pass the dielectric withstanding voltage test. During the test while monitoring leakage current, a high voltage of 1500 volts is applied to the primary and secondary coils, and the primary and the secondary coils must not exchange any leakage current that can cause any bad phenomenon such like short circuit or electric breakdown of the insulating layer.

### SUMMARY

The present invention provides a patch type transformer. The patch type transformer includes an H-shaped magnetic core, a first coil, a second coil, a third coil, and a fourth coil. The H-shaped magnetic core has a columnar winding portion, a first flange portion and a second flange portion. The first flange portion and the second flange portion are respectively connected to two ends of the columnar winding portion. A first pad, a second pad, a third pad, and a fourth pad are sequentially arranged on the first flange portion along a first arrangement direction. A fifth pad, a sixth pad, a seventh pad, and an eighth pad are sequentially arranged on the second flange portion along a second arrangement direction opposite to the first arrangement direction. The first coil is wound on the columnar winding portion. Two ends of the first coil are respectively connected to the first pad and the seventh pad. The second coil is wound on the columnar winding portion. Two ends of the second coil are respectively connected to the third pad and the fifth pad. The third coil is wound on the columnar winding portion. Two ends of the third coil are respectively connected to the second pad and the eighth pad. The fourth coil is wound on the columnar winding portion. Two ends of the fourth coil are respectively connected to the fourth pad and the sixth pad.

In accordance with one or more embodiments of the invention, a winding direction that the first coil and the second coil are wound on the columnar winding portion is opposite to a winding direction that the third coil and the fourth coil are wound on the columnar winding portion.

In accordance with one or more embodiments of the invention, the first pad, the second pad, the third pad, and the fourth pad are arranged on an upper surface of the H-shaped magnetic core. A first portion of the second coil that the second coil is adjacent to the first flange portion and a second portion of the third coil that the third coil is adjacent to the first flange portion are not intersected with each other on the upper surface of the H-shaped magnetic core.

In accordance with one or more embodiments of the invention, a third portion of the first coil that the first coil is adjacent to the first flange portion and a fourth portion of the fourth coil that the fourth coil is adjacent to the first flange portion are insulated and intersected with each other on the upper surface of the H-shaped magnetic core.

In accordance with one or more embodiments of the invention, the first portion of the second coil and the second portion of the third coil are insulated and intersected with each other on a lower surface of the H-shaped magnetic core.

In accordance with one or more embodiments of the invention, the third pad is electrically connected to the fourth pad.

In accordance with one or more embodiments of the invention, the seventh pad is electrically connected to the eighth pad.

In accordance with one or more embodiments of the invention, when the first pad and the second pad are served as input terminals of the patch type transformer, the fifth pad and the sixth pad are served as output terminals of the patch type transformer.

In accordance with one or more embodiments of the invention, when the fifth pad and the sixth pad are served as input terminals of the patch type transformer, the first pad and the second pad are served as output terminals of the patch type transformer.

In accordance with one or more embodiments of the invention, the first coil and the third coil constitute a primary coil group of the patch type transformer.

In accordance with one or more embodiments of the invention, the second coil and the fourth coil constitute a secondary coil group of the patch type transformer.

In accordance with one or more embodiments of the invention, the first flange portion, the columnar winding portion, and the second flange portion are integrally formed.

In accordance with one or more embodiments of the invention, the first arrangement direction and the second arrangement direction are perpendicular to an extending direction of the columnar winding portion.

In accordance with one or more embodiments of the invention, the patch type transformer further includes a back cover arranged on the lower surface of the H-shaped magnetic core so as to cover the H-shaped magnetic core.

The present invention provides a patch type transformer. The patch type transformer includes an H-shaped magnetic core, a first coil, a second coil, a third coil, and a fourth coil. The H-shaped magnetic core has a columnar winding portion, a first flange portion and a second flange portion. The first flange portion and the second flange portion are respectively connected to two ends of the columnar winding portion. A first pad, a second pad, a third pad, and a fourth pad are sequentially arranged on the first flange portion along a first arrangement direction. The first coil is wound on the columnar winding portion. One end of the first coil is connected to the first pad. The second coil is wound on the columnar winding portion. One end of the second coil is connected to the third pad. The third coil is wound on the columnar winding portion. One end of the third coil is connected to the second pad. The fourth coil is wound on the columnar winding portion. One end of the fourth coil is connected to the fourth pad. The first pad, the second pad, the third pad, and the fourth pad are arranged on an upper surface of the H-shaped magnetic core. A first portion of the second coil that the second coil is adjacent to the first flange portion and a second portion of the third coil that the third coil is adjacent to the first flange portion are not intersected with each other on the upper surface of the H-shaped magnetic core. A third portion of the first coil that the first coil is adjacent to the first flange portion and a fourth portion of the fourth coil that the fourth coil is adjacent to the first flange portion are insulated and intersected with each other on the upper surface of the H-shaped magnetic core.

In order to let above mention of the present invention and other objects, features, advantages, and embodiments of the present invention to be more easily understood, the description of the accompanying drawing as follows.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a stereoscopic diagram of a conventional patch type transformer.

FIG. 2 illustrates a top view diagram of the conventional patch type transformer.

FIG. 3 illustrates an equivalent circuit diagram of the conventional patch type transformer.

FIG. 4 illustrates a stereoscopic diagram of a patch type transformer according to some embodiments of the present invention.

FIG. 5 illustrates a top view diagram of the patch type transformer according to some embodiments of the present invention.

FIG. 6 illustrates an equivalent circuit diagram of the patch type transformer according to some embodiments of the present invention.

FIG. 7 is a schematic diagram of a finished product of a patch type transformer according to some embodiments of the present invention.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. The using of “first”, “second”, “third”, etc. in the specification should be understood for identify units or data described by the same terminology, but are not referred to particular order or sequence.

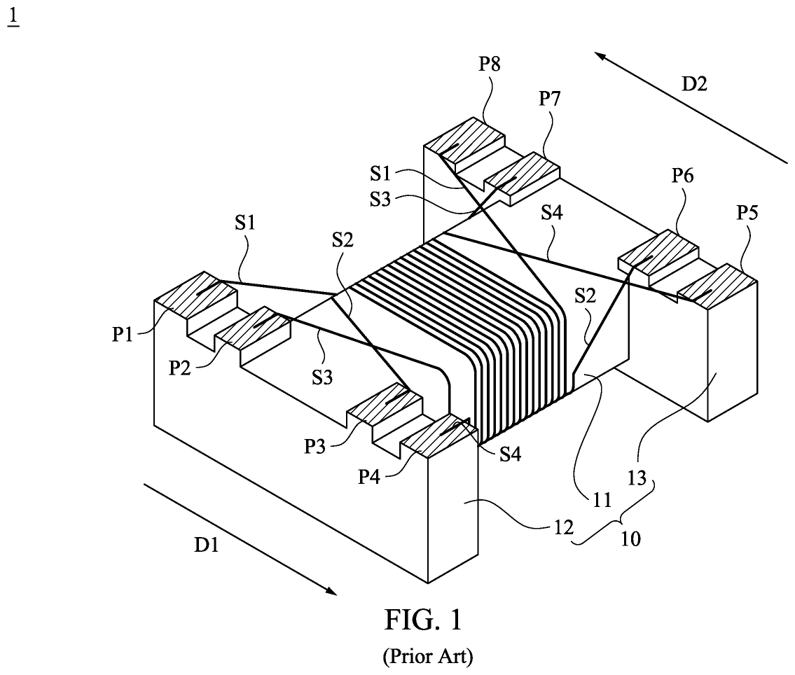

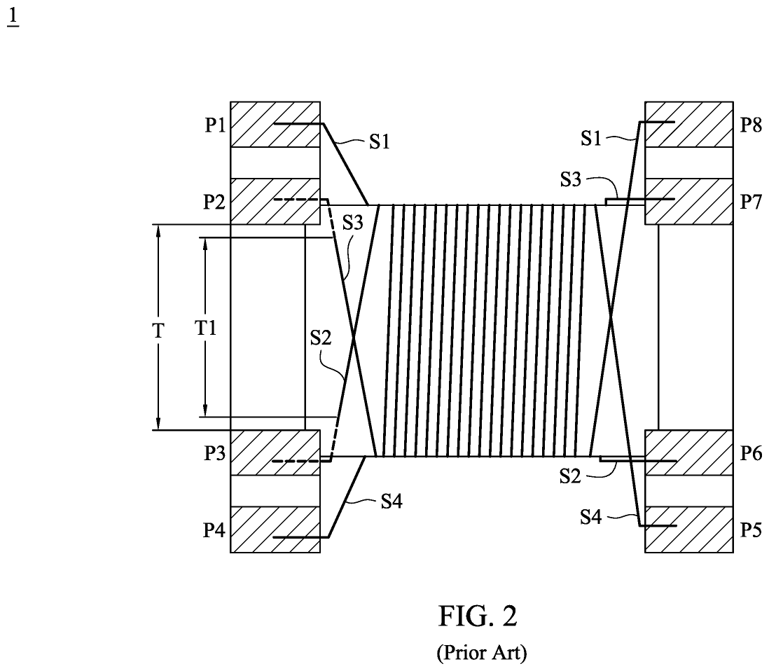

FIG. 1 illustrates a stereoscopic diagram of a conventional patch type transformer 1. FIG. 2 illustrates a top view diagram of the conventional patch type transformer 1. The conventional patch type transformer 1 includes an H-shaped magnetic core 10, a first coil S1, a second coil S2, a third coil S3, and a fourth coil S4. The H-shaped magnetic core 10 has a columnar winding portion 11, a first flange portion 12 and a second flange portion 13. The first flange portion 12 and the second flange portion 13 are respectively connected to two ends of the columnar winding portion 11. The first coil S1, the second coil S2, the third coil S3, and the fourth coil S4 are wound on the columnar winding portion 11 of the H-shaped magnetic core 10.

The conventional patch type transformer 1 is provided with a first pad P1, a second pad P2, a third pad P3, and a fourth pad P4 which are not contact with each other. The first pad P1, the second pad P2, the third pad P3, and the fourth pad P4 are sequentially arranged on the first flange portion 12 along a first arrangement direction D1. The conventional patch type transformer 1 is provided with a fifth pad P5, a sixth pad P6, a seventh pad P7, and an eighth pad P8 which are not contact with each other. The fifth pad P5, the sixth pad P6, the seventh pad P7, and the eighth pad P8 are sequentially arranged on the second flange portion 13 along a second arrangement direction D2. The first arrangement direction D1 is opposite to the second arrangement direction D2.

Two ends of the first coil S1 of the conventional patch type transformer 1 are respectively connected to the first pad P1 and the eighth pad P8. Two ends of the second coil S2 of the conventional patch type transformer 1 are respectively connected to the third pad P3 and the sixth pad P6. Two ends of the third coil S3 of the conventional patch type transformer 1 are respectively connected to the second pad P2 and the seventh pad P7. Two ends of the fourth coil S4 of the conventional patch type transformer 1 are respectively connected to the fourth pad P4 and the fifth pad P5. A winding direction that the first coil S1 and the second coil S2 are wound on the columnar winding portion 11 is opposite to a winding direction that the third coil S3 and the fourth coil S4 are wound on the columnar winding portion 11.

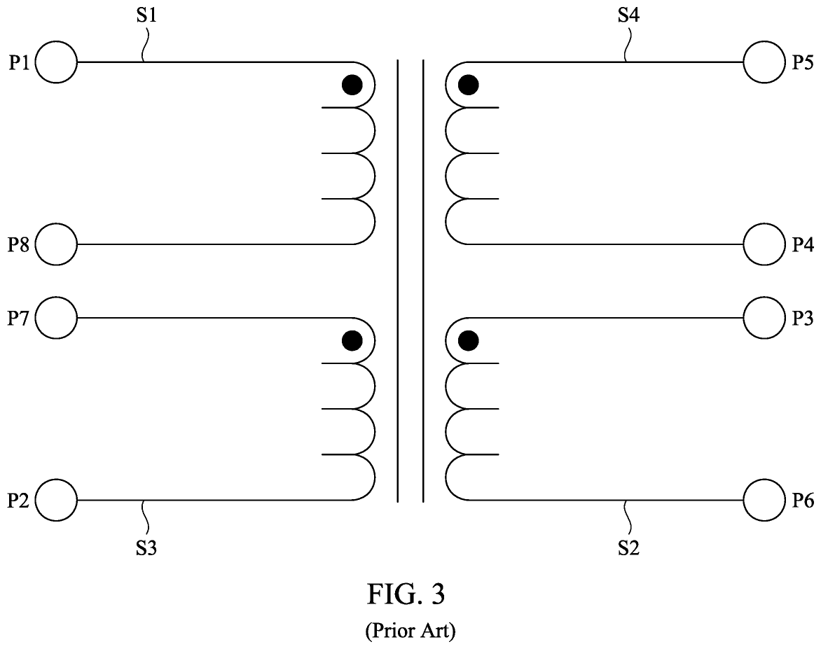

FIG. 3 illustrates an equivalent circuit diagram of the conventional patch type transformer 1. When the first coil S1 which is connected to the first pad P1 and the eighth pad P8 and the third coil S3 which is connected to the second pad P2 and the seventh pad P7 are served as the input terminal of the conventional patch type transformer 1, the fourth coil S4 which is connected to the fourth pad P4 and the fifth pad P5 and the second coil S2 which is connected to the third pad P3 and the sixth pad P6 are served as the output terminal of the conventional patch type transformer 1. When the first coil S1 and the third coil S3 are served as the output terminal of the conventional patch type transformer 1, the fourth coil S4 and the second coil S2 are served as the input terminal of the conventional patch type transformer 1.

Returning to FIG. 2, the first coil S1, the second coil S2, the third coil S3, and the fourth coil S4 of the conventional patch type transformer 1 are insulated varnished copper wires. During the process of soldering connecting one end of the insulated varnished copper wire to the corresponding pad, due to the effect of high temperature soldering, the length that the varnish (i.e., the insulated layer) of the insulated varnished copper wire is melted will inevitably be longer than expected. This phenomenon is called “burn back”.

During the withstand voltage test, when the electrical distance of the electronic product is shorter, the electronic product is more likely to have the phenomenon of poor withstand voltage. For example, if there is no burn back, the electrical distance of the conventional patch type transformer 1 is the minimum distance T between the second pad P2 and the third pad P3. However, due to burn back (i.e., if there is the phenomenon of burn back), the electrical distance of the conventional patch type transformer 1 is shortened to the shortest distance T1 between the exposed copper wire (indicated by the dotted line in FIG. 2) of the third coil S3 connected to the second pad P2 and the exposed copper wire (indicated by the dotted line in FIG. 2) of the second coil S2 connected to the third pad P3. In addition, when the more serious the burn back is, the shorter the electrical distance of the electronic product is, and the more likely the electronic product is to have the phenomenon of poor withstand voltage. In other words, due to burn back, the conventional patch type transformer 1 is prone to shorten the shortest distance T1, resulting in the phenomenon of poor withstand voltage. In order to improve the above-mentioned defects of the conventional patch type transformer 1, the present invention provides an improved patch type transformer 2.

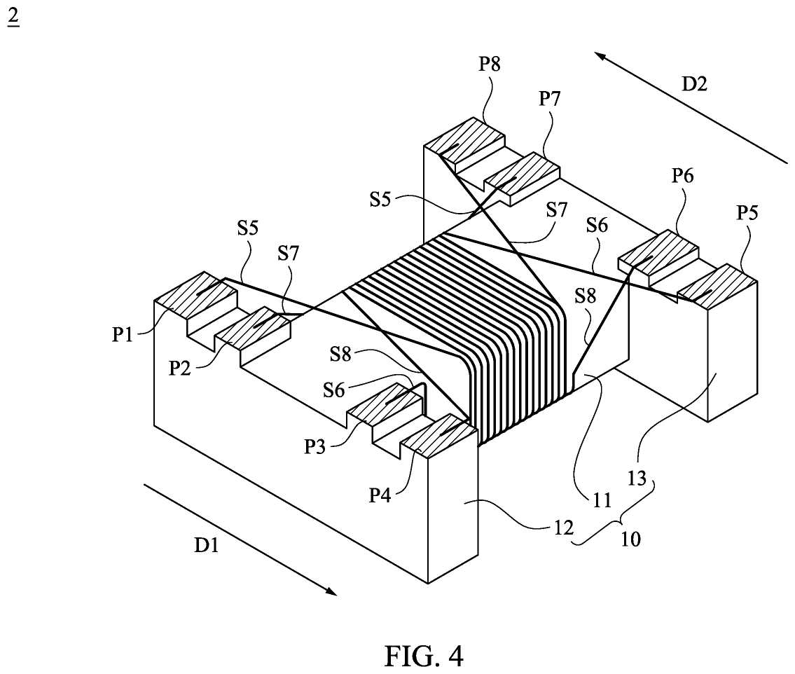

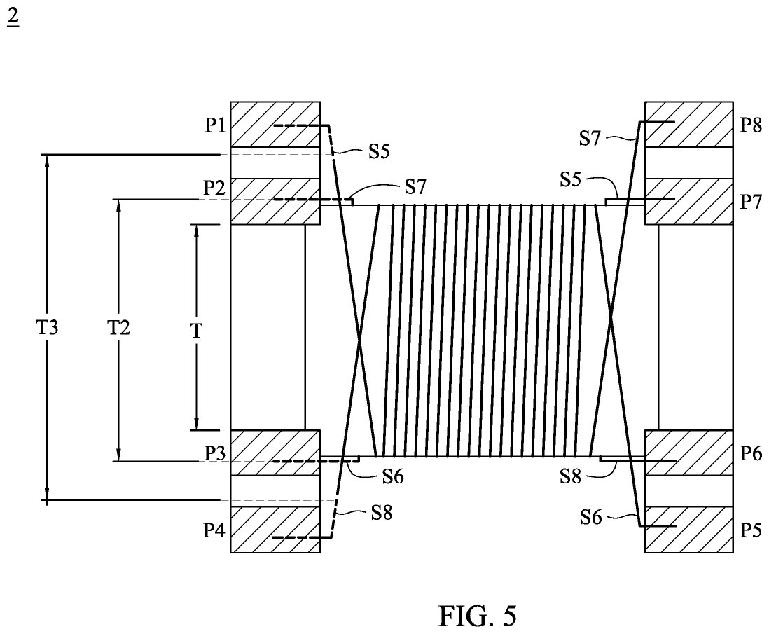

FIG. 4 illustrates a stereoscopic diagram of a patch type transformer 2 according to some embodiments of the present invention. FIG. 5 illustrates a top view diagram of the patch type transformer 2 according to some embodiments of the present invention. The patch type transformer 2 includes an H-shaped magnetic core 10, a first coil S5, a second coil S6, a third coil S7, and a fourth coil S8. The H-shaped magnetic core 10 has a columnar winding portion 11, a first flange portion 12 and a second flange portion 13. The first flange portion 12 and the second flange portion 13 are respectively connected to two ends of the columnar winding portion 11. In some embodiments of the present invention, the first flange portion 12, the columnar winding portion 11, and the second flange portion 13 are integrally formed and constitute the H-shaped magnetic core 10. The first coil S5, the second coil S6, the third coil S7, and the fourth coil S8 are wound on the columnar winding portion 11 of the H-shaped magnetic core 10.

The patch type transformer 2 is provided with a first pad P1, a second pad P2, a third pad P3, and a fourth pad P4 which are not contact with each other. The first pad P1, the second pad P2, the third pad P3, and the fourth pad P4 are sequentially arranged on the first flange portion 12 along a first arrangement direction D1. The patch type transformer 2 is provided with a fifth pad P5, a sixth pad P6, a seventh pad P7, and an eighth pad P8 which are not contact with each other. The fifth pad P5, the sixth pad P6, the seventh pad P7, and the eighth pad P8 are sequentially arranged on the second flange portion 13 along a second arrangement direction D2. The first arrangement direction D1 is opposite to the second arrangement direction D2. In some embodiments of the present invention, as shown in FIG. 4, the first arrangement direction D1 and the second arrangement direction D2 are perpendicular to an extending direction of the columnar winding portion 11.

Two ends of the first coil S5 of the patch type transformer 2 are respectively connected to the first pad P1 and the seventh pad P7. Two ends of the second coil S6 of the patch type transformer 2 are respectively connected to the third pad P3 and the fifth pad P5. Two ends of the third coil S7 of the patch type transformer 2 are respectively connected to the second pad P2 and the eighth pad P8. Two ends of the fourth coil S8 of the patch type transformer 2 are respectively connected to the fourth pad P4 and the sixth pad P6.

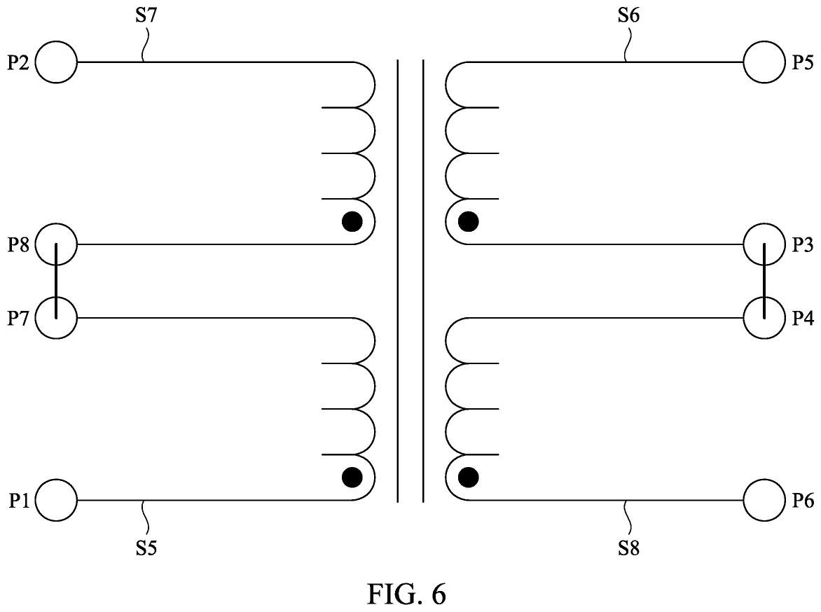

FIG. 6 illustrates an equivalent circuit diagram of the patch type transformer 2 according to some embodiments of the present invention. The first coil S5 and the third coil S7 constitute a primary coil group of the patch type transformer 2. The second coil S6 and the fourth coil S8 constitute a secondary coil group of the patch type transformer 2.

A winding direction of the first coil S5 wound on the columnar winding portion 11 is identical to a winding direction of the second coil S6 wound on the columnar winding portion 11. The winding direction of the first coil S5 and the winding direction of the second coil S6 are defined as the forward direction herein. A winding direction of the third coil S7 wound on the columnar winding portion 11 is identical to a winding direction of the fourth coil S8 wound on the columnar winding portion 11. The winding direction of the third coil S7 and the winding direction of the fourth coil S8 are defined as the backward direction herein. Specifically, a winding direction that the first coil S5 and the second coil S6 are wound on the columnar winding portion 11 is opposite to a winding direction that the third coil S7 and the fourth coil S8 are wound on the columnar winding portion 11.

When the patch type transformer 2 is used, the seventh pad P7 is electrically connected to the eighth pad P8 and the third pad P3 is electrically connected to the fourth pad P4. In other words, the seventh pad P7 is shorted (i.e., short-connected) to the eighth pad P8, and the third pad P3 is shorted (i.e., short-connected) to the fourth pad P4. At this time, the first pad P1, the second pad P2, the fifth pad P5, and the sixth pad P6 can be served as the input terminal and output terminal of the patch type transformer 2. In other words, when the first pad P1 and the second pad P2 are served as the input terminal of the patch type transformer 2, the fifth pad P5 and the sixth pad P6 are served as the output terminal of the patch type transformer 2. When the fifth pad P5 and the pad P6 are served as the input terminal of the patch type transformer 2, the first pad P1 and the second pad P2 are served as the output terminal of the patch type transformer 2.

Returning to FIG. 5, the first coil S5, the second coil S5, the third coil S7, and the fourth coil S8 of the patch type transformer 2 are insulated varnished copper wires. During the process of soldering connecting one end of the insulated varnished copper wire to the corresponding pad, due to the effect of high temperature soldering, the phenomenon of burn back will inevitably occur.

For example, if there is no burn back, the electrical distance of the patch type transformer 2 is the minimum distance T between the second pad P2 and the third pad P3. However, if there is the phenomenon of burn back, as shown in FIG. 5, with respect to the second coil S6 and the third coil S7 at the first flange portion 12, the electrical distance of the second coil S6 and the third coil S7 is the shortest distance T2 between the exposed copper wire (indicated by the dotted line in FIG. 5) of the third coil S7 connected to the second pad P2 and the exposed copper wire (indicated by the dotted line in FIG. 5) of the second coil S6 connected to the third pad P3. The aforementioned shortest distance T2 is greater than the minimum distance T between the second pad P2 and the third pad P3. Therefore, even if there is the phenomenon of burn back, the electrical distance of the patch type transformer 2 will not be reduced (the electrical distance of the patch type transformer 2 is still the minimum distance T between the second pad P2 and the third pad P3). Thus, the present invention improves the defect of the conventional patch type transformer that is easy to cause poor withstand voltage due to the shortened electrical distance caused by the phenomenon of burn back.

In addition, if there is the phenomenon of burn back, with respect to the first coil S5 and the fourth coil S8 at the first flange portion 12, the electrical distance of the first coil S5 and the fourth coil S8 is the shortest distance T3 between the exposed copper wire (indicated by the dashed line in FIG. 5) of the first coil S5 connected to the first pad P1 and the exposed copper wire (indicated by the dashed line in FIG. 5) of the fourth coil S8 connected to the fourth pad P4. The aforementioned shortest distance T3 will not be less than the minimum distance T between the second pad P2 and the third pad P3. In other words, with respect to the first coil S5 and the fourth coil S8 at the first flange portion 12, because the distance between the first pad P1 and the fourth pad P4 is relatively large, even if there is the phenomenon of burn back, the electrical distance of the first coil S5 and the fourth coil S8 at the first flange portion 12 will not be smaller than the minimum distance T between the second pad P2 and the third pad P3.

In detail, as shown in FIG. 4 and FIG. 5, the H-shaped magnetic core 10 has an upper surface and a lower surface opposite to each other. The first pad P1, the second pad P2, the third pad P3, and the fourth pad P4 are arranged on the upper surface of the H-shaped magnetic core 10. A first portion of the second coil S6 that the second coil S6 is adjacent to the first flange portion 12 and the second portion of the third coil S7 that the third coil S7 is adjacent to the first flange portion 12 are insulated and intersected with each other on a lower surface of the H-shaped magnetic core 10, as shown in FIG. 4 and FIG. 5. A third portion of the first coil S5 that the first coil S5 is adjacent to the first flange portion 12 and a fourth portion of the fourth coil S8 that the fourth coil S8 is adjacent to the first flange portion 12 are insulated and intersected with each other on the upper surface of the H-shaped magnetic core 10, as shown in FIG. 4 and FIG. 5. In other words, the first portion of the second coil S6 that the second coil S6 is adjacent to the first flange portion 12 and the second portion of the third coil S7 that the third coil S7 is adjacent to the first flange portion 12 are not intersected with each other on the upper surface of the H-shaped magnetic core 10.

Specifically, the first portion of the second coil S6 that the second coil S6 is adjacent to the first flange portion 12 and the second portion of the third coil S7 that the third coil S7 is adjacent to the first flange portion 12 are not intersected with each other on the upper surface of the H-shaped magnetic core 10 but are intersected with each other on the lower surface of the H-shaped magnetic core 10. Therefore, even if there is the phenomenon of burn back, the electrical distance of the patch type transformer 2 will not be reduced. This is because, with respect to the second coil S6 and the third coil S7 at the first flange portion 12, the electrical distance of the second coil S6 and the third coil S7 is still the minimum distance T between the second pad P2 and the third pad P3.

Specifically, the third portion of the first coil S5 that the first coil S5 is adjacent to the first flange portion 12 and the fourth portion of the fourth coil S8 that the fourth coil S8 is adjacent to the first flange portion 12 are intersected with each other on the upper surface of the H-shaped magnetic core 10. Because the distance between the pad P1 and the fourth pad P4 is relatively large, and thus even if there is the phenomenon of burn back, the electrical distance of the first coil S5 and the fourth coil S8 at the first flange portion 12 will not be smaller than the minimum distance T between the second pad P2 and the third pad P3. In other words, the third portion of the first coil S5 that the first coil S5 is adjacent to the first flange portion 12 and the fourth portion of the fourth coil S8 that the fourth coil S8 is adjacent to the first flange portion 12 are intersected with each other on the upper surface of the H-shaped magnetic core 10 and will not affect the withstand voltage performance of the electronic product.

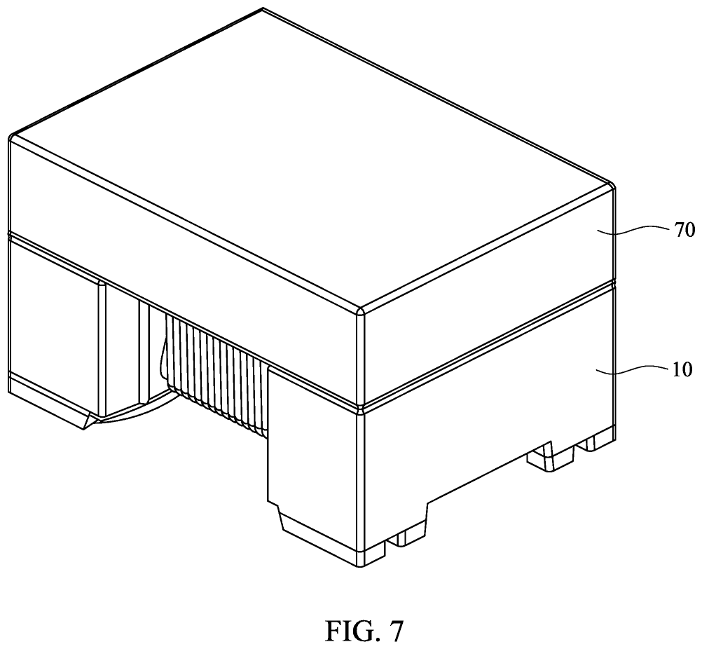

FIG. 7 is a schematic diagram of a finished product of a patch type transformer 2 according to some embodiments of the present invention. Specifically, the present invention further adds a back cover 70 arranged on the lower surface of the H-shaped magnetic core 10, so that the back cover 70 covers the H-shaped magnetic core 10. The back cover 70 is used to increase the inductance of the patch type transformer 2, thereby ensuring sufficient inductance.

From the above description, the present invention provides a patch type transformer. This patch type transformer will not reduce the electrical distance due to the phenomenon of burn back, and thus the electronic product will not be prone to have the phenomenon of poor withstand voltage. That is, the patch type transformer of the present invention can maintain a certain electrical distance, so that the electronic product can pass the withstand voltage test.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A patch type transformer, comprising:
an H-shaped magnetic core having a columnar winding portion, a first flange portion and a second flange portion, wherein the first flange portion and the second flange portion are respectively connected to two ends of the columnar winding portion, wherein a first pad, a second pad, a third pad, and a fourth pad are sequentially arranged on the first flange portion along a first arrangement direction, wherein a fifth pad, a sixth pad, a seventh pad, and an eighth pad are sequentially arranged on the second flange portion along a second arrangement direction opposite to the first arrangement direction;
a first coil wound on the columnar winding portion, wherein two ends of the first coil are respectively connected to the first pad and the seventh pad;
a second coil wound on the columnar winding portion, wherein two ends of the second coil are respectively connected to the third pad and the fifth pad;
a third coil wound on the columnar winding portion, wherein two ends of the third coil are respectively connected to the second pad and the eighth pad; and
a fourth coil wound on the columnar winding portion, wherein two ends of the fourth coil are respectively connected to the fourth pad and the sixth pad.

2. The patch type transformer of claim 1, wherein a winding direction that the first coil and the second coil are wound on the columnar winding portion is opposite to a winding direction that the third coil and the fourth coil are wound on the columnar winding portion.

3. The patch type transformer of claim 1, wherein the first pad, the second pad, the third pad, and the fourth pad are arranged on an upper surface of the H-shaped magnetic core, wherein a first portion of the second coil that the second coil is adjacent to the first flange portion and a second portion of the third coil that the third coil is adjacent to the first flange portion are not intersected with each other on the upper surface of the H-shaped magnetic core.

4. The patch type transformer of claim 3, wherein a third portion of the first coil that the first coil is adjacent to the first flange portion and a fourth portion of the fourth coil that the fourth coil is adjacent to the first flange portion are insulated and intersected with each other on the upper surface of the H-shaped magnetic core.

5. The patch type transformer of claim 3, wherein the first portion of the second coil and the second portion of the third coil are insulated and intersected with each other on a lower surface of the H-shaped magnetic core.

6. The patch type transformer of claim 1, wherein the third pad is electrically connected to the fourth pad.

7. The patch type transformer of claim 1, wherein the seventh pad is electrically connected to the eighth pad.

8. The patch type transformer of claim 1, wherein when the first pad and the second pad are served as input terminals of the patch type transformer, the fifth pad and the sixth pad are served as output terminals of the patch type transformer.

9. The patch type transformer of claim 1, wherein when the fifth pad and the sixth pad are served as input terminals of the patch type transformer, the first pad and the second pad are served as output terminals of the patch type transformer.

10. The patch type transformer of claim 1, wherein the first coil and the third coil constitute a primary coil group of the patch type transformer.

11. The patch type transformer of claim 10, wherein the second coil and the fourth coil constitute a secondary coil group of the patch type transformer.

12. The patch type transformer of claim 1, wherein the first flange portion, the columnar winding portion, and the second flange portion are integrally formed.

13. The patch type transformer of claim 1, wherein the first arrangement direction and the second arrangement direction are perpendicular to an extending direction of the columnar winding portion.

14. The patch type transformer of claim 5, further comprising:
a back cover arranged on the lower surface of the H-shaped magnetic core so as to cover the H-shaped magnetic core.

15. A patch type transformer, comprising:
an H-shaped magnetic core having a columnar winding portion, a first flange portion and a second flange portion, wherein the first flange portion and the second flange portion are respectively connected to two ends of the columnar winding portion, wherein a first pad, a second pad, a third pad, and a fourth pad are sequentially arranged on the first flange portion along a first arrangement direction;
a first coil wound on the columnar winding portion, wherein one end of the first coil is connected to the first pad;
a second coil wound on the columnar winding portion, wherein one end of the second coil is connected to the third pad;
a third coil wound on the columnar winding portion, wherein one end of the third coil is connected to the second pad; and
a fourth coil wound on the columnar winding portion, wherein one end of the fourth coil is connected to the fourth pad;
wherein the first pad, the second pad, the third pad, and the fourth pad are arranged on an upper surface of the H-shaped magnetic core;
wherein a first portion of the second coil that the second coil is adjacent to the first flange portion and a second portion of the third coil that the third coil is adjacent to the first flange portion are not intersected with each other on the upper surface of the H-shaped magnetic core;
wherein a third portion of the first coil that the first coil is adjacent to the first flange portion and a fourth portion of the fourth coil that the fourth coil is adjacent to the first flange portion are insulated and intersected with each other on the upper surface of the H-shaped magnetic core.
